(19) United States
(12) Patent Application Publication
(10) Pub. No.: US 2026/0307524 A1
(43) Pub. Date: Oct. 8, 2026

(54) IDENTIFICATION APPARATUS

(71) Applicant: TOYOTA JIDOSHA KABUSHIKI KAISHA, Toyota-shi (JP)

(72) Inventor: Tohru NAKAMURA, Toyota-shi (JP)

(73) Assignee: TOYOTA JIDOSHA KABUSHIKI KAISHA, Toyota-shi (JP)

(21) Appl. No.: 19/444,481

(22) Filed: Jan. 9, 2026

(30) Foreign Application Priority Data
Feb. 3, 2025 (JP) 2025-016120

(51) Int. Cl. B60L 53/65; B60L 53/62

(52) U.S. Cl. CPC B60L 53/65; B60L 53/62

(57) ABSTRACT

An identification apparatus includes a storage device and an execution device. The storage device stores, for each type of vehicle, a charging profile that is obtained when a battery is charged in accordance with a predetermined identification charging command issued from the power supply facility. The execution device acquires a response charging profile, which is generated in response to the dentification charging command when a target vehicle charges the battery in accordance with the identification charging command. The execution device identifies a type of the target vehicle based on the response charging profile and the charging profile.

### CROSS-REFERENCE TO RELATED APPLICATIONS

This application is based upon and claims the benefit of priority from Japanese Patent Application No. 2015-016120, filed on Feb. 3, 2025, the entire contents of which are incorporated herein by reference.

### BACKGROUND

### 1. Field

The present disclosure relates to an identification apparatus.

### 2. Description of Related Art

JP2018-061433A discloses a management system. The management system includes a power supply facility, a vehicle having a battery to be charged by the power supply facility, and a management center that manages charging of the battery. The management center identifies the vehicle based on an identification number acquired from the vehicle.

In the management system disclosed in the above publication, the management center cannot identify the type of vehicle unless it acquires the identification number from the vehicle. Accordingly, a technique is required that allows the type of vehicle to be identified even without necessarily acquiring the identification number from the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An identification apparatus according to an aspect of the present disclosure is configured to identify a type of vehicle having a battery that is charged by a power supply facility. The identification apparatus includes a storage device and processing circuitry. The storage device is configured to store, for each type of vehicle, a charging profile that is obtained when the battery is charged in accordance with a predetermined identification charging command. The identification charging command is issued from the power supply facility. The processing circuitry is configured to acquire a response charging profile. The response charging profile is generated in response to the identification charging command when a target vehicle charges the battery in accordance with the identification charging command. The target vehicle is subject to charging. The storage device is configured to identify a type of the target vehicle based on the response charging profile and the charging profile.

Other features and aspects will be apparent from the following detailed description, the drawings, and the claims.

### BRIEF DESCRIPTION OF THE DRAWINGS

FIG. 1 is a schematic diagram showing a management system according to an embodiment.

FIG. 2 is a schematic diagram illustrating a state where the vehicle is connected to the power supply facility in the management system of FIG. 1.

FIG. 3 is a graph illustrating an identification charging command to be sent from the power supply facility to the vehicle in the management system of FIG. 2.

FIG. 4 is a graph illustrating a first charging profile.

FIG. 5 is a graph illustrating a second charging profile.

FIG. 6 is a graph illustrating a third charging profile.

FIG. 7 is a graph illustrating a fourth charging profile.

FIG. 8 is a graph illustrating a fifth charging profile.

FIG. 9 is a flowchart illustrating a series of processes for identifying the type of vehicle performed by the power supply facility of FIG. 1.

FIG. 10 is a flowchart illustrating a series of processes for identifying the type of vehicle performed by the server of FIG. 1.

FIG. 11 is a flowchart illustrating details of the process in step S22 in FIG. 10.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

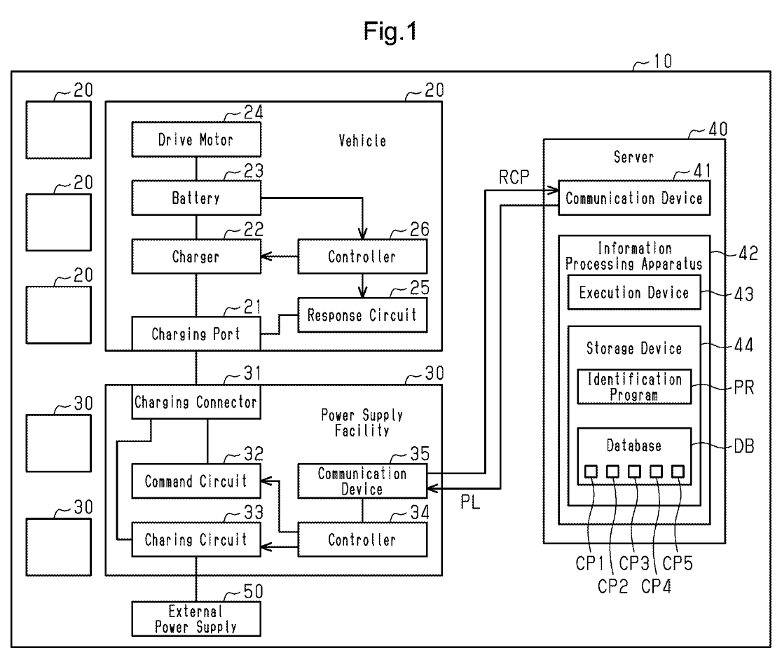

As shown in FIG. 1, a management system 10 includes vehicles 20, power supply facilities 30, a server 40, and an external power supply 50. The management system 10 manages charging of the vehicles 20 performed by the power supply facilities 30.

### Vehicle and Power Supply Facility

Each vehicle 20 includes a charging port 21, a charger 22, a battery 23, and a drive motor 24. The vehicle 20 is a battery electric vehicle. Each power supply facility 30 includes a charging connector 31 that is connectable to the corresponding charging port 21. Connecting the charging connector 31 to the charging port 21 allows the power supply facility 30 to charge the battery 23. Connecting the charging connector 31 to the charging port 21 allows the vehicle 20 to respond to the power supply facility 30.

The drive motor 24 is a drive source for the vehicle 20. The drive motor 24 drives the vehicle 20 using electrical energy stored in the battery 23. The battery 23 stores electrical energy for operating the drive motor 24.

The charger 22 includes a relay that switches connection and disconnection of an electric power path between the charging port 21 and the battery 23, and a power conversion circuit. The battery 23 is charged by controlling the charger 22.

The vehicle 20 includes a response circuit 25 and a controller 26. The response circuit 25 enables the vehicle 20 to respond to a charging command that is issued from the power supply facility 30. The response circuit 25 generates a response charging profile RCP, which will be described later, using a PWM signal.

The controller 26 controls the charger 22 to charge the battery 23. Upon detecting that the charging connector 31 has been connected to the charging port 21, the controller 26 controls the charger 22 to start charging the battery 23. The controller 26 controls the charger 22 to stop charging the battery 23 based on the state of charge of the battery 23. In FIG. 1, detailed illustration is provided only for one vehicle 20, while illustration of the other vehicles 20 is partially omitted.

Each power supply facility 30 supplies electric power from the external power supply 50 to the corresponding vehicle 20 to charge the battery 23 of the vehicle 20. The power supply facility 30 is electric vehicle supply equipment (EVSE). The power supply facility 30 includes the charging connector 31, a command circuit 32, a charging circuit 33, a controller 34, and a communication device 35.

Each charging connector 31 is connectable to the charging port 21 of the corresponding vehicle 20. The charging connector 31 is connected to the command circuit 32 using a cable. The charging connector 31 is connected to the external power supply 50 via the charging circuit 33 using a cable. The external power supply 50 is provided outside the power supply facility 30. Connecting the charging connector 31 to the charging port 21 allows the power supply facility 30 to supply electric power from the external power supply 50 to the battery 23 via the charging circuit 33.

The command circuit 32 sends a charging command to the vehicle 20. Charging the charging connector 31 to the charging port 21 allows the command circuit 32 to send a charging command to the vehicle 20. The charging command includes a maximum current command value, which will be described later.

The charging circuit 33 charges the battery 23 from the external power supply 50. Connecting the charging connector 31 to the charging port 21 allows the charging circuit 33 to supply electric power from the external power supply 50 to the battery 23.

The controller 34 controls the supply of power from the external power supply 50 to the battery 23 of the vehicle 20 in accordance with a charging plan PL. The charging plan PL is acquired from the server 40 via the communication device 35. The charging plan PL is time-series data representing a charging power per unit time requested for a predetermined time. In FIG. 1, detailed illustration is provided only for one power supply facility 30, while illustration of the other power supply facilities 30 is partially omitted.

### Server

The server 40 includes a communication device 41 and an information processing apparatus 42. The communication device 41 is communicable with the power supply facility 30 via a wireless communication line.

The information processing apparatus 42 includes an execution device 43, which is processing circuitry, and a storage device 44. The execution device 43 is a CPU including a processor. The storage device 44 is a memory. The storage device 44 stores a database DB and an identification program PR. The information processing apparatus 42 is an identification apparatus in the present embodiment.

As will be described later, the information processing apparatus 42 executes the identification program PR to identify the type of vehicle subject to charging, that is, a target vehicle having the battery 23 that is charged by the power supply facility 30. Then, the information processing apparatus 42 generates the charging plan PL, which is used to charge the battery 23 of the target vehicle from the power supply facility 30, in accordance with the identified type of the target vehicle. The information processing apparatus 42 sends information indicating the generated charging plan PL to the power supply facility 30 via the communication device 41.

### CPLT Function

The power supply facility 30 has a control pilot (CPLT) function. The CPLT function determines whether the charging connector 31 is connected to the charging port 21, and starts charging when a connection is detected.

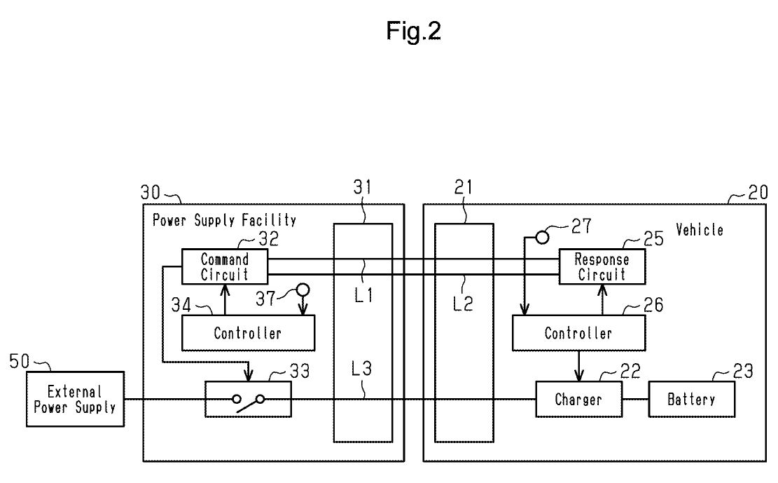

As shown in FIG. 2, with the charging connector 31 connected to the charging port 21, a command line L1 for sending a charging command connects the command circuit 32 to the response circuit 25. The command line L1 is a power line. With the charging connector 31 connected to the charging port 21, a response line L2 for sending a response connects the command circuit 32 to the response circuit 25. The response line L2 is a power line. With the charging connector 31 connected to the charging port 21, a power supply line L3 for supplying power from the external power supply 50 to the battery 23 connects the charging circuit 33 to the charger 22. The power supply line L3 is a power line.

The command circuit 32 includes, for example, a 12-V power supply for detecting whether the charging connector 31 is connected to the charging port 21. The command circuit 32 applies a voltage from the power supply to the command line L1. The response circuit 25 includes a first resistor and a second resistor.

The voltage applied to the command line L1 varies depending on whether the charging connector 31 is connected to the charging port 21, as a result of the presence of the first resistor included in the response circuit 25.

The controller 34 acquires the voltage of the command line L1 from a voltage sensor, which detects the voltage of the command line L1. The controller 34 determines whether the charging connector 31 is connected to the charging port 21 based on the acquired voltage of the command line L1.

Specifically, with the charging connector 31 disconnected from the charging port 21, the voltage of the command line L1 remains at 12 V, which is the voltage applied from a power supply of the command circuit 32. Connecting the charging connector 31 to the charging port 21 changes the voltage of the command line L1 from 12 V to, for example, 9 V, as a result of the presence of the first resistor included in the response circuit 25. Thus, the controller 34 determines that the charging connector 31 has been connected to the charging port 21.

When the controller 34 determines that the charging connector 31 has been connected to the charging port 21, the controller 26 outputs a PWM signal to the command line L1. The voltage range of the PWM signal is, for example, from −12 V to +12 V. The duty ratio range of the PWM signal is, for example, from 5% to 96%. In this case, the PWM signal indicates a value from 6 A to 80 A as the maximum current command value.

The controller 26 acquires the maximum current command value output to the command line L1 from the sensor 27, which detects the PWM signal of the command line L1. Then, in order to indicate that charging can be started, the controller 26 changes the voltage applied to the command line L1 by means of the second resistor included in the response circuit 25. Connecting the second resistor to the command line L1 changes the voltage of the command line L1 to, for example, 6 V. Thus, the controller 34 detects that the vehicle 20 can start charging.

Upon detecting that charging can be started by the vehicle 20, the controller 34 controls, for example, a switch included in the charging circuit 33 to apply an AC voltage of 200 V from the external power supply 50 to the power supply line L3.

When an AC voltage of 200 V is applied to the power supply line L3, the controller 26 controls the charger 22. Under this control, the controller 26 starts the battery 23 such that the electric power to be supplied to the battery 23 remains at a current that is less than or equal to the maximum current command value and converts into a DC voltage using the power conversion circuit.

As described above, upon connection of the charging connector 31 to the charging port 21, the power supply facility 30 starts charging the battery 23 with the CPLT function. Power line communication is carried out between the power supply facility 30 and the vehicle 20. Thus, the power supply facility 30 cannot acquire vehicle identification information, such as an identification number for identifying the vehicle 20, from the vehicle 20.

As shown in FIG. 1, the communication device 35 is communicable with the server 40 via a wireless communication line. The vehicle 20 cannot perform wireless communication with the server 40 via a wireless communication line. Thus, the server 40 cannot acquire vehicle identification information from the vehicle 20.

### Identification Charging Command and Charging Profile

As shown in FIG. 2, the controller 34 controls the command circuit 32 to output a predetermined identification charging command DCC to the vehicle 20 via the command line L1.

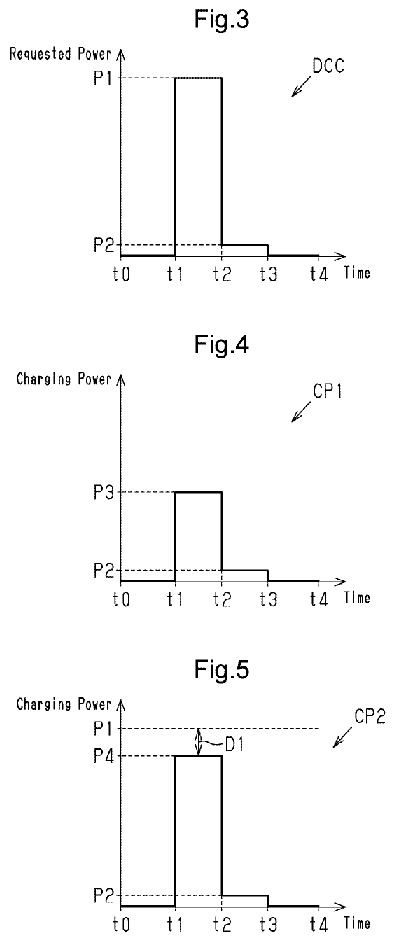

As shown in FIG. 3, the identification charging command DCC is time-series data representing a requested power to the vehicle 20 (i.e., the power at which the vehicle is to be charged). Specifically, the identification charging command DCC instructs that the requested power be zero from time t0 to time t1. The identification charging command DCC instructs that the requested power be a first power P1 from time t1 to time t2. The first power P1 is a first specified power in the present embodiment. The first power P1 is, for example, 6 kW. A change in power from zero to the first power P1 is greater than or equal to a specified magnitude. Thus, the identification charging command DCC includes a charging request that has a change in electric power that is greater than or equal to a specified magnitude. The specified magnitude is a power magnitude predetermined through testing or simulation in order to identify the type of vehicle 20. The specified magnitude is, for example, 3 kW.

The identification charging command DCC instructs that the requested power be a second power P2 from time t2 to time t3. The second power P2 is a second specified power, which is smaller than the first specified power. The second power P2 is, for example, 0.5 kW. A change in power from the first power P1 to the second power P2 is greater than or equal to a specified magnitude. Thus, the identification charging command DCC includes a charging request that has a change in electric power that is greater than or equal to a specified magnitude.

The identification charging command DCC instructs that the requested power be zero from time t3 to time t4. At time t4, the identification charging command DCC ends the present charging command. As described above, the identification charging command DCC is time-series data representing the requested power from time t0 to time t4.

When the vehicle 20 charges the battery 23 in accordance with a charging command, the controller 26 charges the battery 23 such that the current is less than or equal to the maximum current command value. Accordingly, even when an identical charging command is obtained, the battery 23 of each type of vehicle 20 is charged at a charging power different from the requested power specified in the charging command.

As shown in FIG. 1, the database DB includes five types of charging profiles CP corresponding to different types of vehicle 20, respectively. That is, the storage device 44 stores each charging profile CP for the corresponding type of vehicle 20. In the present embodiment, the charging profiles CP include first to fifth charging profiles CP1 to CP5, which respectively correspond to first to fifth types of vehicles 20. The charging profiles CP are identification charging profiles.

The charging profiles CP are time-series data representing a charging power that is obtained when the vehicle 20 charges the battery 23 in accordance with the identification charging command DCC. The charging profiles CP are obtained in advance through testing or simulation.

Specifically, the database DB includes the first charging profile CP1. The first charging profile CP1 is generated when the first type of vehicle 20 charges the battery 23 in accordance with the identification charging command DCC.

The database DB includes the second charging profile CP2. The second charging profile CP2 is generated when the second type of vehicle 20 charges the battery 23 in accordance with the identification charging command DCC.

The database DB includes the third charging profile CP3. The third charging profile CP3 is generated when the third type of vehicle 20 charges the battery 23 in accordance with the identification charging command DCC.

The database DB includes the fourth charging profile CP4. The fourth charging profile CP4 is generated when the fourth type of vehicle 20 charges the battery 23 in accordance with the identification charging command DCC.

The database DB includes the fifth charging profile CP5. The fifth charging profile CP5 is generated when the fifth type of vehicle 20 charges the battery 23 in accordance with the identification charging command DCC.

As shown in FIG. 4, the first charging profile CP1 indicates that the vehicle 20 charged the battery 23 in accordance with the identification charging command DCC but did not charge the battery 23 at the first power P1 according to a request to charge at the first power P1.

Specifically, the first charging profile CP1 indicates that the charging power is zero from time t0 to time t1. The first charging profile CP1 indicates that the charging power is the third power P3 from time t1 to time t2 although charging at the first power P1 is requested during the same period. The third power P3 is a charging power that is less than the first power P1 and greater than or equal to the second power P2. Specifically, the third power P3 is a charging power that is half of the first power P1.

The first charging profile CP1 indicates that the charging power is the second power P2 from time t2 to time t3. The first charging profile CP1 indicates that the charging power is zero from time t3 to time t4.

Referring to FIG. 5, the second charging profile CP2 indicates that there is a difference D between the charging power and the requested power when the first power P1 is requested in the identification charging command DCC.

Specifically, the second charging profile CP2 indicates that the charging power is zero from time t0 to time t1. The second charging profile CP2 indicates that the charging power is a fourth power P4 from time t1 to time t2. The fourth power P4 is greater than half of the first power P1. The fourth power P4 has the difference D1 from the first power P1. Specifically, the charging power from time t1 to time t2 is 5.95 kW. Thus, the difference D1 between the charging power and the requested power from time t1 to time t2 is 0.05 kW.

The second charging profile CP2 indicates that the charging power is the second power P2 from time t2 to time t3. The second charging profile CP2 indicates that the charging power is zero from time t3 to time t4.

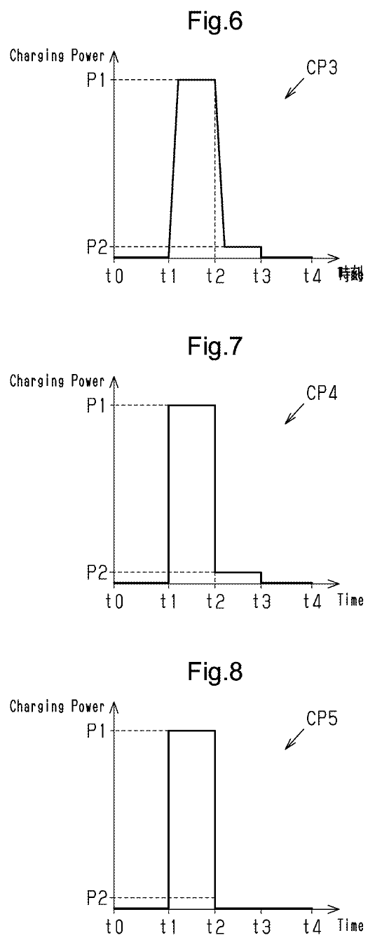

As shown in FIG. 6, the third charging profile CP3 indicates that there is a response delay in the charging power with respect to a change in a requested power that is greater than or equal to a specified magnitude when the vehicle 20 charges the battery 23 in accordance with the identification charging command DCC.

Specifically, the third charging profile CP3 indicates that the charging power is zero from time t0 to time t1. The third charging profile CP3 indicates that the charging power gradually increases from zero to the first power P1 between time t1 and time t2 and then remains the first power P1. That is, the third charging profile CP3 indicates that there is a response delay in a change in which the requested power increases from zero to the first power P1.

The third charging profile CP3 indicates that the charging power gradually decreases from the first power P1 to the second power P2 between time t2 and time t3 and then remains the second power P2. That is, the third charging profile CP3 indicates that there is a response delay in a change in which the requested power decreases from the first power P1 to the second power P2. The third charging profile CP3 indicates that the charging power is zero from time t3 to time t4.

As shown in FIG. 7, the fourth charging profile CP4 indicates that the charging power has the same profile as that of the identification charging command DCC when the vehicle 20 charges the battery 23 in accordance with the identification charging command DCC.

Specifically, the fourth charging profile CP4 indicates that the charging power is zero from time t0 to time t1. The fourth charging profile CP4 indicates that the charging power is the first power P1 from time t1 to time t2.

The fourth charging profile CP4 indicates that the charging power is the second power P2 from time t2 to time t3. The fourth charging profile CP4 indicates that the charging power is zero from time t3 to time t4.

As shown in FIG. 8, the fifth charging profile CP5 indicates that the battery 23 was charged in accordance with the identification charging command DCC but was not charged according to a request to charge at the second power P2.

Specifically, the fifth charging profile CP5 indicates that the charging power is zero from time t0 to time t1. The fifth charging profile CP5 indicates that the charging power is the first power P1 from time t1 to time t2.

The fifth charging profile CP5 indicates that the charging power is zero from time t2 to time t3 although charging at the second power P2 is requested during the same period. Thus, the fifth charging profile CP5 indicates that the battery 23 is not charged from time t2 to time t3. The fifth charging profile CP5 indicates that the charging power is zero from time t3 to time t4.

### Vehicle Type Identification

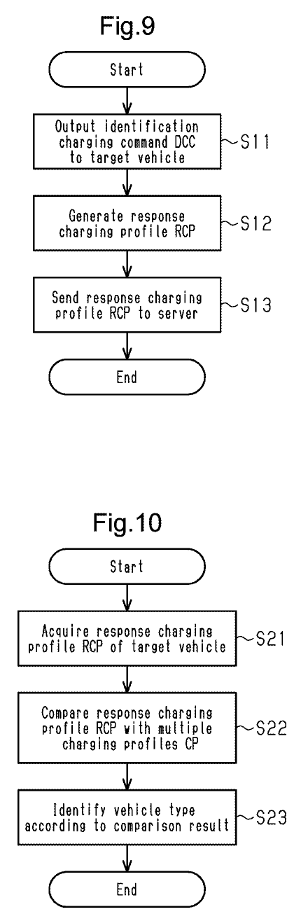

Referring to FIG. 9, upon connection of the charging connector 31 to the charging port 21 of a target vehicle, the controller 34 starts a series of processes for identifying the type of the target vehicle. Upon starting the series of processes for identifying the type of the target vehicle, the controller 34 first performs the process of step S11.

In step S11, the controller 34 outputs the identification charging command DCC to the target vehicle. Then, the controller 34 advances the process to step S12.

In step S12, the controller 34 generates a response charging profile RCP in response to the identification charging command DCC when the target vehicle charges the battery 23 in accordance with the identification charging command DCC. The response charging profile RCP is time-series data representing a charging power obtained when the target vehicle charges the battery 23 in accordance with the identification charging command DCC.

Specifically, in the target vehicle to which the identification charging command DCC has been input, the controller 26 controls the response circuit 25 to output the time-series data, which represents the charging power obtained when charging is performed in accordance with the identification charging command DCC, to the power supply facility 30 via the response line L2. The response circuit 25 outputs a PWM signal to the response line L2. The PWM signal indicates the value of current during charging. The controller 34 calculates the value of current during charging based on a detection value from the sensor 37, which detects the PWM signal. The controller 34 calculates the charging power by multiplying, the calculated value of current, the value of voltage obtained during charging by the charging circuit 33. Then, the controller 34 generates, as the response charging profile RCP, time-series data representing the calculated charging power. Then, the controller 34 advances the process to step S13.

In step S13, the controller 34 sends data indicating the generated response charging profile RCP from the communication device 35 to the server 40. Subsequently, the controller 34 ends the series of processes in the current cycle.

As shown in FIG. 10, after the communication device 41 receives the data indicating the response charging profile RCP, the information processing apparatus 42 starts a series of processes for identifying the type of the target vehicle. In the information processing apparatus 42, the execution device 43 starts executing the identification program PR to start the series of processes for identifying the type of the target vehicle. Thus, the information processing apparatus 42 functions as the identification apparatus.

Upon starting execution of the identification program PR, the execution device 43 first starts the process of step S21. In step S21, the execution device 43 acquires the response charging profile RCP of the target vehicle received by the communication device 41. Then, the execution device 43 advances the process to step S22.

In step S22, the execution device 43 compares the response charging profile RCP with multiple charging profiles CP. In step S22, the execution device 43 outputs, as a comparison result, one of the charging profiles CP that match the response charging profile RCP.

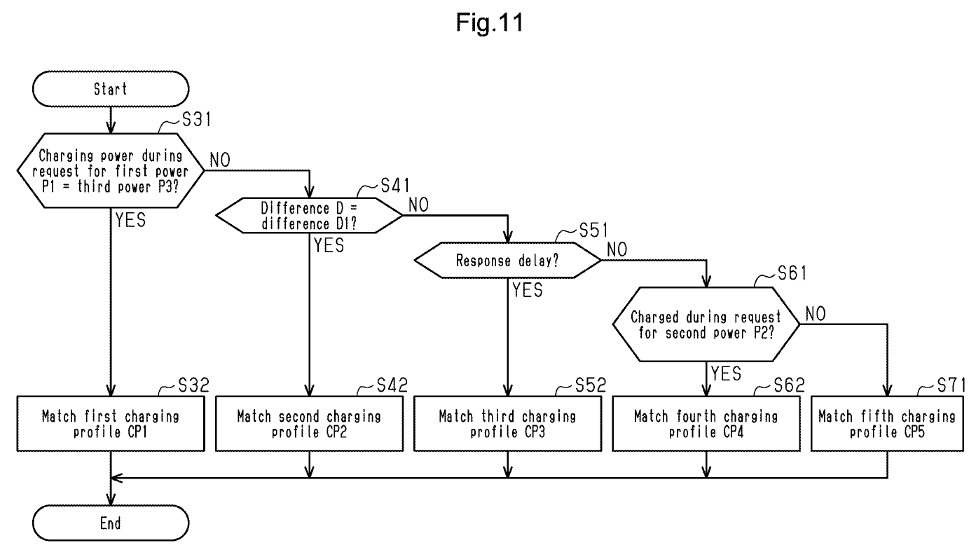

As shown in FIG. 11, upon starting the process of step S22, the execution device 43 first performs the process of step S31. In step S31, the execution device 43 compares the response charging profile RCP with the first charging profile CP1. Then, the execution device 43 determines whether the charging power obtained when the first power P1 is requested is the third power P3 in the response charging profile RCP.

When the charging power during a request for the first power P1 is the third power P3 in the response charging profile RCP (S31: YES), the execution device 43 advances the process to step S32.

In step S32, the execution device 43 determines that the response charging profile RCP matches the first charging profile CP1. Subsequently, the execution device 43 ends the process of step S22 in the current cycle.

When the charging power during a request for the first power P1 is requested is not the third power P3 in the response charging profile RCP (S31: NO), the execution device 43 advances the process to step S41.

In step S41, the execution device 43 compares the response charging profile RCP with the second charging profile CP2. Then, the execution device 43 determines whether the difference D between the first power P1 and the fourth power P4, which is the charging power from time t1 to time t2 in the response charging profile RCP, is the difference D1.

When the difference D between the fourth power P4 in the response charging profile RCP and the first power P1 is the difference D1 (S41: YES), the execution device 43 advances the process to step S42.

In step S42, the execution device 43 determines that the response charging profile RCP matches the second charging profile CP2. Subsequently, the execution device 43 ends the process of step S22 in the current cycle.

When the difference D between the fourth power P4 in the response charging profile RCP and the first power P1 is not the difference D1 (S41: NO), the execution device 43 advances the process to step S51.

In step S51, the execution device 43 compares the response charging profile RCP with the third charging profile CP3. Then, the execution device 43 determines whether the response charging profile RCP has the same charging delay as the third charging profile CP3. Specifically, the execution device 43 determines whether the slope of the charging power from time t1 to the time at which the charging power reaches the first power P1 in the response charging profile RCP matches the slope of the charging power in the third charging profile CP3.

When the response charging profile RCP has the same charging delay as the third charging profile CP3 (S51: YES), the execution device 43 advances the process to step S52.

In step S52, the execution device 43 determines that the response charging profile RCP matches the third charging profile CP3. Subsequently, the execution device 43 ends the process of step S22 in the current cycle.

When the response charging profile RCP does not have the same charging delay as the third charging profile CP3 (S51: NO), the execution device 43 advances the process to step S61.

In step S61, the execution device 43 compares the response charging profile RCP with the fourth charging profile CP4 and the fifth charging profile CP5. Then, the execution device 43 determines whether charging is performed when the second power P2 is requested in the response charging profile RCP. That is, the execution device 43 determines whether the charging power from time t2 to time t3 in the response charging profile RCP matches the charging power from time t2 to time t3 in the fourth charging profile CP4 or matches the charging power from time t2 to time t3 in the fifth charging profile CP5.

In the response charging profile RCP, when charging is performed during a request for the second power P2 (S61: YES), the execution device 43 advances the process to step S62.

In step S62, the execution device 43 determines that the response charging profile RCP matches the fourth charging profile CP4. Subsequently, the execution device 43 ends the process of step S22 in the current cycle.

In the response charging profile RCP, when charging is not performed during a request for the second power P2 (S61: NO), the execution device 43 advances the process to step S71.

In step S71, the execution device 43 determines that the response charging profile RCP matches the fifth charging profile CP5. Subsequently, the execution device 43 ends the process of step S22 in the current cycle.

As illustrated in FIG. 10, upon ending the process of step S22, the execution device 43 advances the process to step S23. In step S23, the execution device 43 identifies the type of the target vehicle based on the result of comparison between the response charging profile RCP and the charging profiles CP.

Specifically, the execution device 43 determines that the type of the target vehicle is associated with the charging profile CP that matches the response charging profile RCP in step S22. Thus, for example, when the execution device 43 outputs a comparison result indicating that the response charging profile RCP matches the first charging profile CP1 through the process of step S32, the execution device 43 determines that the type of the target vehicle is the first type.

For example, when the execution device 43 outputs a comparison result indicating that the response charging profile RCP matches the second charging profile CP2 through the process of step S42, the execution device 43 determines that the type of the target vehicle is the second type.

For example, when the execution device 43 outputs a comparison result indicating that the response charging profile RCP matches the third charging profile CP3 through the process of step S52, the execution device 43 determines that the type of the target vehicle is the third type.

For example, when the execution device 43 outputs a comparison result indicating that the response charging profile RCP matches the fourth charging profile CP4 through the process of step S62, the execution device 43 determines that the type of the target vehicle is the fourth type.

For example, when the execution device 43 outputs a comparison result indicating that the response charging profile RCP matches the fifth charging profile CP5 through the process of step S62, the execution device 43 determines that the type of the target vehicle is the fifth type.

In this manner, the execution device 43 identifies the type of the target vehicle based on the response charging profile RCP and multiple charging profiles CP. The execution device 43 identifies the type of the target vehicle according to the result of comparison between the response charging profile RCP and multiple charging profiles CP.

Specifically, the execution device 43 identifies the type of the target vehicle based on whether, as indicated by the response charging profile RCP, charging is performed at the first power P1 and whether, as indicated by the charging profile CP, charging is performed at the first power P1.

The execution device 43 identifies the type of the target vehicle based on the difference D between the charging power indicated by the response charging profile RCP and the first power P1 and the difference D between the charging power indicated by the charging profile CP and the first power P1.

The execution device 43 identifies the type of the target vehicle based on the response delay, as indicated by the response charging profile RCP, with respect to a change in the requested power and the response delay, as indicated by the charging profile CP, with respect to a change in the requested power.

The execution device 43 identifies the type of the target vehicle based on whether, as indicated by the response charging profile RCP, charging is performed in response to a request for the second power P2 and whether, as indicated by the charging profile CP, charging is performed in response to a request for the second power P2.

Upon ending the process of step S23, the execution device 43 ends the series of processes in the current cycle. Subsequently, the execution device 43 sends, for example, the charging plan PL corresponding to the identified type of the target vehicle to the power supply facility 30 as a charging command. Then, the power supply facility 30 outputs the charging command such that charging can be performed in accordance with the charging plan PL corresponding to the type of the target vehicle.

### Operation of the Present Embodiment

In the embodiment, upon connection of the charging connector 31 to the charging port 21 of the target vehicle, the identification charging command DCC is output from the power supply facility 30 to a target vehicle. Next, the response charging profile RCP generated when the target vehicle charges the battery 23 in accordance with the identification charging command DCC is output from the target vehicle to the power supply facility 30.

Subsequently, information indicating the response charging profile RCP is sent from the power supply facility 30 to the server 40. Then, the information processing apparatus 42 acquires the response charging profile RCP from the communication device 41. The information processing apparatus 42 identifies the type of the target vehicle based on the acquired response charging profile RCP and stored multiple charging profiles CP.

### Advantages of the Present Embodiment

(1) The vehicle 20 does not perform wireless communication with the server 40. The vehicle 20 is communicable with the power supply facility 30 only via power line communication. Thus, the vehicle 20 cannot send vehicle identification information, such as an identification number for identifying the vehicle 20, to the server 40.

The execution device 43 acquires the response charging profile RCP, and identifies the type of a target vehicle based on the acquired response charging profile RCP and the stored charging profiles CP. This allows the information processing apparatus 42 to identify the type of the target vehicle based on the response charging profile RCP and the charging profiles CP without acquiring the vehicle identification information.

(2) The response charging profile RCP is time-series data representing the charging power obtained when the vehicle 20 charges the battery 23 in accordance with the identification charging command DCC. Thus, compared to when, for example, identifying the type of vehicle 20 based on only the value of the charging power at a specified time, the information processing apparatus 42 identifies a larger number of vehicles 20.

(3) When the information processing apparatus 42 identifies the type of vehicle 20, the execution device 43 identifies the type of vehicle 20 according to the result of comparison between the response charging profile RCP and the charging profile CP. This allows the information processing apparatus 42 to identify, as the type of the target vehicle, the type of vehicle 20 associated with one of the charging profiles CP that match the response charging profile RCP.

(4) The identification charging command DCC includes a request to charge at the first power P1, which is a predetermined first specified power. When the information processing apparatus 42 identifies the type of vehicle 20, the execution device 43 identifies the type of the target vehicle based on whether, as indicated by the response charging profile RCP, charging is performed at the first power P1 and whether, as indicated by the charging profile CP, charging is performed at the first power P1.

Thus, for example, when the vehicle 20 that is charged with only the third power P3 despite the requested power of the first power P1, such as the vehicle 20 of the first type, is the target vehicle, the information processing apparatus 42 identifies the type of the target vehicle.

(5) The identification charging command DCC includes a charging request that has a change in electric power that is greater than or equal to a specified magnitude. When the information processing apparatus 42 identifies the type of vehicle 20, the execution device 43 identifies the type of the target vehicle based on the response delay, as indicated by the response charging profile RCP, with respect to the change in the electric power and the response delay, as indicated by the charging profile CP, with respect to the change in the electric power.

Thus, for example, when the vehicle 20 having a response delay with respect to the change in the requested power, such as the vehicle 20 of the third type, is the target vehicle, the information processing apparatus 42 identifies the type of the target vehicle.

(6) The identification charging command DCC includes a request to charge at the second power P2, which is a predetermined second specified power. The execution device 43 identifies the type of target vehicle based on whether, as indicated by the response charging profile RCP, charging is performed in response to a request for the second power P2 and whether, as indicated by the charging profile CP, charging is performed in response to a request for the second power P2.

For example, in the vehicle 20 of the fifth type, when the second power P2 is lower than a lower limit value of chargeable electric power, charging is not performed despite the requested power of the second power P2. In the above configuration, if this type of vehicle 20 is the target vehicle, the information processing apparatus 42 identifies the type of the target vehicle.

(7) The identification charging command DCC includes charging at the first power P1, which is the predetermined first specified power. When the information processing apparatus 42 identifies the type of vehicle 20, the execution device 43 identifies the type of the target vehicle based on the difference D in the response charging profile RCP and the difference D in the charging profile CP.

Thus, for example, when the vehicle 20 having a characteristic of causing the difference D1 from the requested power of the first power P1, such as the vehicle 20 of the second type, is the target vehicle, the information processing apparatus 42 identifies the type of the target vehicle.

### Modifications

The above embodiment may be modified as follows. The above embodiment and the following modifications can be combined as long as the combined modifications remain technically consistent with each other.

The vehicle 20 is not limited to a battery electric vehicle (BEV) including only the drive motor 24, which uses electrical energy stored in the battery 23, as a drive source. The vehicle 20 only needs to include the battery 23. For example, the vehicle 20 may be a plug-in hybrid electric vehicle (PHEV).

The vehicle 20 may be wirelessly communicable with the server 40. The vehicle 20 may be configured to send vehicle identification information to the server 40. The information processing apparatus 42 may identify the type of vehicle 20 either using vehicle identification information or using the identification program PR. Even in this case, the information processing apparatus 42 identifies the type of vehicle 20 by executing the identification program PR without necessarily acquiring vehicle identification information.

The power supply facility 30 may include connectors and circuits for respective power supply systems so as to support multiple types of power supply systems, such as a DC system in addition to, for example, an AC system.

The communication between the power supply facility 30 and the vehicle 20 is not limited to power line communication. For example, the communication between the power supply facility 30 and the vehicle 20 may be performed using a CAN. In this case, the power supply facility 30 may acquire the response charging profile RCP by acquiring, through a CAN, information indicating the response charging profile RCP from the vehicle 20.

In the above embodiment, the server 40 does not have to acquire the response charging profile RCP from the power supply facility 30. For example, when the server 40 and the vehicle 20 are wirelessly communicable with each other, the server 40 may acquire the response charging profile RCP from the vehicle 20.

In the above embodiment, the identification apparatus is included in the server 40. Instead, the identification apparatus may be included in the power supply facility 30 or in a device that relays communication between the power supply facility 30 and the server 40. The device that relays communication between the power supply facility 30 and the server 40 may be, for example, an energy management system that collectively manages the supply of power to multiple vehicles 20.

In the above embodiment, the information processing apparatus 42 is provided with the execution device 43, which is processing circuitry including one or more processors that run computer programs (software) to execute various processes. However, the information processing apparatus 42 may be provided with processing circuitry including one or more dedicated hardware circuits, such as application-specific integrated circuits (ASICs) that execute at least some of the processes. Alternatively, the information processing apparatus 42 may be provided with processing circuitry including a combination of one or more processors and one or more dedicated hardware circuits. The processor includes a CPU and a memory, such as a RAM and a ROM. The memory stores program codes or instructions configured to cause the CPU to execute the processes. The memory, or a computer-readable medium, includes any type of medium that is accessible by general-purpose computers and dedicated computers. The same applies to the controllers 26 and 34.

The response charging profile RCP is not limited to the time-series data representing the charging power obtained when charging is performed based on the identification charging command DCC. For example, the response charging profile RCP may represent data indicating the average value of the charging power obtained when the battery 23 is charged in accordance with the identification charging command DCC. The response charging profile RCP only needs to be data indicating a response to the charging of the battery 23 in accordance with the identification charging command DCC.

The result of comparison between the response charging profile RCP and the charging profiles CP is not limited to the example of the above embodiment. For example, fitting may be performed between the response charging profile RCP and each of the charging profiles CP so as to identify the type of vehicle 20 based on the best-matching charging profile CP.

The information processing apparatus 42 does not have to identify the type of vehicle 20 according to the result of comparison between the response charging profile RCP and the charging profile CP. For example, the information processing apparatus 42 may calculate the difference between the response charging profile RCP and the identification charging command DCC, and identify, as the type of the target vehicle, the type of vehicle 20 associated with the charging profile CP having the calculated difference. In this manner, the information processing apparatus 42 only needs to identify the type of vehicle 20 based on the response charging profile RCP and the charging profile CP.

The identification charging command DCC does not have to include a request to charge at the first power P1. The information processing apparatus 42 does not have to identify the type of the target vehicle based on whether, as indicated by the response charging profile RCP, charging is performed at the first power P1 and whether, as indicated by the charging profile CP, charging is performed at the first power P1.

The identification charging command DCC does not have to include a charging request that has a change in electric power that is greater than or equal to a specified magnitude. The information processing apparatus 42 does not have to identify the type of the target vehicle based on the response delay, as indicated by the response charging profile RCP, with respect to the change in the electric power and the response delay, as indicated by the charging profile CP, with respect to the change in the electric power.

The identification charging command DCC does not have to include a request to charge at the second power P2. The information processing apparatus 42 does not have to identify the type of target vehicle based on whether, as indicated by the response charging profile RCP, charging is performed in response to a request for the second power P2 and whether, as indicated by the charging profile CP, charging is performed in response to a request for the second power P2.

The information processing apparatus 42 does not have to identify the type of the target vehicle based on the difference D in the response charging profile RCP and the difference D in the charging profile CP.

The charging profiles CP are not limited to the examples of the above embodiment. For example, there may be a charging profile CP having the characteristic of the first charging profile CP1 and the characteristic of the third charging profile CP3.

The information processing apparatus 42 only needs to identify the type of vehicle 20 based on the response charging profile RCP and the charging profile CP. For example, the information processing apparatus 42 may identify the type of vehicle 20 by inputting the response charging profile RCP into a trained model and cause the model to output the type of vehicle 20. In this case, the storage device 44 stores a trained model using, as training data, multiple charging profiles CP and the types of vehicle 20 respectively associated with the respective charging profiles CP. Then, the execution device 43 inputs the response charging profile RCP into the trained model and identifies, as the type of the target vehicle, the type of vehicle 20 output from the trained model. Even in this case, the information processing apparatus 42 identifies the type of vehicle 20 based on the response charging profile RCP and the charging profile CP.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An identification apparatus configured to identify a type of vehicle having a battery that is charged by a power supply facility, the identification apparatus comprising:
a storage device; and
processing circuitry, wherein
the storage device is configured to store, for each type of vehicle, a charging profile that is obtained when the battery is charged in accordance with a predetermined identification charging command, the identification charging command being issued from the power supply facility, and
the processing circuitry is configured to:
acquire a response charging profile, the response charging profile being generated in response to the identification charging command when a target vehicle charges the battery in accordance with the identification charging command, the target vehicle being subject to charging; and
identify a type of the target vehicle based on the response charging profile and the charging profile.

2. The identification apparatus according to claim 1, wherein
the response charging profile is time-series data representing a charging power that is obtained when the target vehicle charges the battery in accordance with the identification charging command.

3. The identification apparatus according to claim 1, wherein
the processing circuitry is configured to identify the type of the target vehicle according to a result of a comparison between the response charging profile and the charging profile.

4. The identification apparatus according to claim 1, wherein
the identification charging command includes a request to charge at a predetermined specified power,
each of the charging profile and the response charging profile indicates whether charging at the specified power has been performed in response to the request to charge at the specified power, and
the processing circuitry is configured to identify the type of the target vehicle based on whether, as indicated by the response charging profile, charging has been performed at the specified power and whether, as indicated by the charging profile, charging has been performed at the specified power.

5. The identification apparatus according to claim 1, wherein
the identification charging command includes a charging request that has a change in electric power that is greater than or equal to a specified magnitude, and
the processing circuitry is configured to identify the type of the target vehicle based on a response delay, as indicated by the response charging profile, with respect to the change and a response delay, as indicated by the charging profile, with respect to the change.

6. The identification apparatus according to claim 1, wherein
the identification charging command includes a request to charge at a predetermined specified power,
each of the charging profile and the response charging profile indicates whether charging has been performed in response to the request to charge at the specified power, and
the processing circuitry is configured to identify the type of the target vehicle based on whether, as indicated by the response charging profile, charging has been performed and whether, as indicated by the charging profile, charging has been performed.

7. The identification apparatus according to claim 1, wherein
the identification charging command includes a request to charge at a predetermined specified power, and
the processing circuitry is configured to:
obtain a first difference, the first difference being between the specified power and a charging power that is indicated by the response charging profile during a request to charge at the specified power;
obtain a second difference, the second difference being between the specified power and a charging power that is indicated by the charging profile during a request to charge at the specified power; and
identify the type of the target vehicle based on the first difference and the second difference.
